(19) United States
(12) Patent Application Publication
(10) Pub. No.: US 2023/0350720 A1
(43) Pub. Date: Nov. 2, 2023

(54) Chaining Services in an Accelerator Device

(71) Applicant: Intel Corporation, Santa Clara, CA (US)

(72) Inventors: Marian Horgan, Cork (IE); Laurent Coquerel, Limerick (IE); John Browne, Limerick (IE)

(73) Assignee: Intel Corporation, Santa Clara, CA (US)

(21) Appl. No.: 18/221,057

(22) Filed: Jul. 12, 2023

(51) Int. Cl. G06F 9/50; G06F 9/48

(52) U.S. Cl. CPC G06F 9/5027; G06F 9/4881

(57) ABSTRACT

An accelerator device may receive, from an application, an application programming interface (API) call to chain an encryption operation for data and a data transformation operation for the data. The accelerator device may cause two or more hardware accelerators of the accelerator device to execute the encryption operation for the data and the data transformation operation for the data based on the API call.

### BACKGROUND

Accelerator devices may perform various computing operations. However, these devices may perform these operations independently. Therefore, requesting software may issue separate requests for each independent operation. Doing so may introduce latency and generally decrease system performance.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates a logic flow 600 in accordance with one embodiment.

FIG. 7 illustrates an aspect of the subject matter in accordance with one embodiment.

### DETAILED DESCRIPTION

Embodiments disclosed herein provide techniques to cause an accelerator device to chain two or more operations using a single request. The operations may include, but are not limited to, two or more of: hash operations, compression operations, decompression operations, encryption operations, decryption operations, or any combination thereof. The operations may collectively be referred to herein as “data transformation operations.” For example, a software application may need to compress data and encrypt the compressed data. The application may issue a single request to the accelerator device to cause the accelerator device to compress the data and encrypt the compressed data. In some embodiments, some operations may be performed in parallel. For example, the accelerator device may hash data and compress the data in parallel. Embodiments are not limited in these contexts.

In some embodiments, the application may establish a session with the accelerator device that includes parameters for chaining multiple operations. For example, the application may specify a cryptographic algorithm for encryption and/or decryption, algorithms for compression and/or decompression, integrity algorithms, compression levels, checksum types, hash functions, and the like. The accelerator device may apply these parameters to all relevant requests issued by the application during the session. For example, the application may specify a first encryption algorithm and a first compression algorithm as session parameters. Often, the application may issue multiple requests to compress and encrypt data, e.g., to compress and encrypt multiple portions of a single file and/or to compress and encrypt multiple files. The accelerator device may apply the first compression algorithm and the first encryption algorithm for each compression/encryption request during the session without requiring the application to specify the first compression algorithm and the first encryption algorithm with each request. Instead, the accelerator device reuses the session parameters for each request, which improves system performance.

Embodiments disclosed herein may improve system performance by allowing applications to issue a single request for multiple processing operations to an accelerator device. The accelerator device may include logic to chain the multiple processing operations. Because the accelerator device does not need to return an output of one operation to the application and the application does not need to issue another request to perform another data transformation operation, system latency may be reduced and system throughput may be increased. Furthermore, the accelerator device may include logic to perform two or more requested operations in parallel, which may improve processing speed relative to performing the operations in in sequence.

Furthermore, in some embodiments, the firmware of the accelerator device used to chain operations may be less costly (e.g., may require less storage space and/or fewer processing resources), which may improve system performance. In some embodiments, storage solutions (e.g., encrypted file systems) may realize improved performance and/or security, as packets may be compressed and encrypted with a single call. Furthermore, data integrity checks may be supported by including hash operations in a single request. Doing so may ensure end-to-end data integrity. More generally, end-to-end data integrity may be ensured for any types of operations performed on the data. Because some data may not be exposed to memory, the security of data may be improved. In some embodiments, communication data (e.g., packets) may be more secure, as packets may be compressed then encrypted, which may increase the overall network bandwidth while keeping the data secure.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

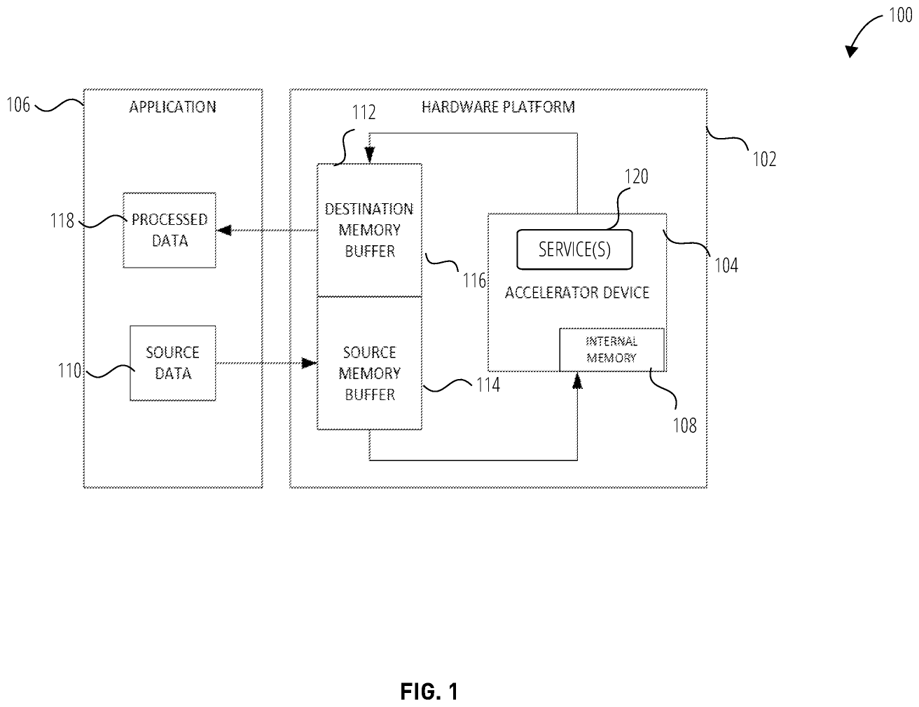

FIG. 1 illustrates an embodiment of a system 100. As shown, the system includes a hardware platform 102 that includes an accelerator device 104 and memory 112. The hardware platform 102 is representative of any type of computing platform, such as a computer, cloud computing node, personal computer (PC), server, an Infrastructure Processing Unit (IPU), a data processing unit (DPU), and the like. The accelerator device 104 is representative of any type of device that provides hardware acceleration, such as a graphics processing unit (GPU), cryptographic accelerator, cryptographic co-processor, an offload engine, and the like. The accelerator device 104 may provide a plurality of different services 120 (which may be referred to herein as “functions” or “operations” or “data transformation operations”) that are implemented in circuitry (not pictured) of the accelerator device 104. Examples of the services 120 provided by the accelerator device 104 include encryption services, decryption services, compression services, decompression services, hash computation services, data integrity services, graphics processing services, mathematical services, computation services, or any other type of service. Embodiments are not limited in this context, as the services may generally support any operation. As used herein, a data transformation operation may include any operation that is applied to data. For example, a data transformation operation may be any operation that receives input data and transforms the input data to an output data that is different than the input data. Therefore, data transformation operations may include, but are not limited to, encryption operations, decryption operations, compression operations, decompression operations, hash computation operations, data integrity operations, graphics processing operations, mathematical operations, computation operations, or any other type of operation.

An application 106 may execute on a processor (not depicted) provided by the hardware platform 102. In some embodiments, the application 106 executes on a system external to the hardware platform 102. Although depicted as an application, the application 106 may be any type of executable code, such as a process, a thread, a virtual machine, a container, a microservice, etc. The application 106 may use the services 120 of the accelerator device 104 to process source data 110. Often, the application 106 requires multiple services 120 to be applied to the source data 110. Embodiments disclosed herein allow the application 106 to issue a single request to cause the accelerator device 104 to chain any combination of two or more of the services 120. For example, the application 106 may issue a single chaining request to cause the accelerator device 104 to perform a compression operation on the source data 110 and encrypt the compressed source data 110. In some embodiments, the chaining requests are implemented as application programming interface (API) calls to one or more APIs provided by the accelerator device 104.

In some embodiments, the chained operations may be called individually. For example the application 106 may issue a first request to cause the accelerator device 104 to compress the data and a second request to cause the accelerator device 104 to encrypt the compressed data as chained operations. In some embodiments, the chained operations may be called together, e.g., in a single chaining request to cause the accelerator device 104 to compress then encrypt the data. Embodiments are not limited in these contexts.

In some embodiments, the application 106 may establish a session with the accelerator device 104, e.g., before issuing one or more chaining requests. The session establishment may include the application 106 providing parameters for different operations to be performed by the accelerator device 104. More generally, a session includes one or more software and/or hardware configuration parameters that can be reused over multiple chaining requests. For example, the parameters may include cryptographic algorithms to be used for encryption/decryption operations, hash functions to be used for hash computations, integrity algorithms to be used for data integrity verification (e.g., SHA-based or CRC-based algorithms), compression algorithms to be used for compression/decompression operations, compression levels, checksum types, or any other parameter.

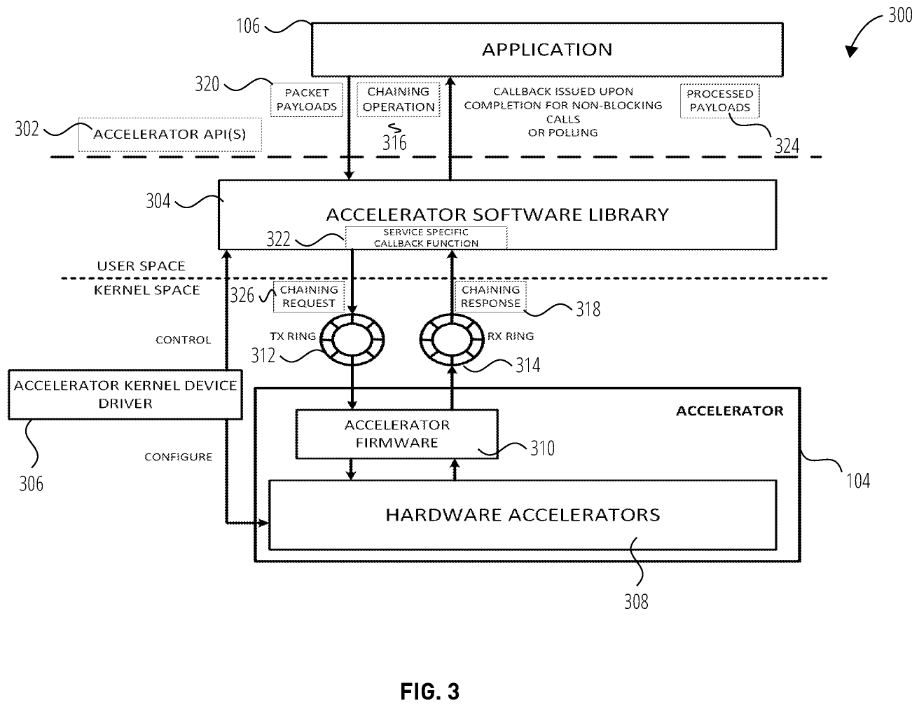

Once the session is established, the session parameters are cached by a software library (e.g., software library 304 of FIG. 3) of the accelerator device 104 and reused when the application 106 issues one or more chaining requests. For example, if the application 106 has a large file that needs to be processed, the application 106 may issue a plurality of chaining requests, each chaining request associated with a respective portion of the file. The accelerator device 104 may use the session parameters to process each portion of the file. Doing so may improve system performance by reducing the amount of information transmitted by the application 106 to the accelerator device 104, which in turn may reduce the amount of processing required for the accelerator device 104 to process a given request. As another example, the application 106 may issue multiple chaining requests to process different files during a given session. The accelerator device 104 may process each request (and each file) using the session parameters.

For example, as shown, source data 110 may be stored in a source memory buffer 114 of the memory 112. The application 106 may issue a chaining request to the accelerator device 104. The accelerator device 104 may determine an order of the requested operations (e.g., compress then encrypt). The accelerator device 104 may load the source data 110 into the memory 108 of the accelerator device 104. The accelerator device 104 may use the session parameters to process the chaining request. The accelerator device 104 may then use one or more hardware accelerators to perform the compression operation on the source data 110 (e.g., based on the session parameters associated with compression and any additional compression parameters specified as part of the chaining request). Once the source data 110 is compressed, the accelerator device 104 uses one or more hardware accelerators to encrypt the compressed source data 110 (e.g., based on the session parameters associated with encryption or any additional encryption parameters specified as part of the chaining request), thereby generating processed data 118. The processed data 118 may then be stored in a destination memory buffer 116 of the memory 112. The application 106 may then consume the processed data 118. For example, the application may store the processed data 118 in a storage medium. Embodiments are not limited in this context.

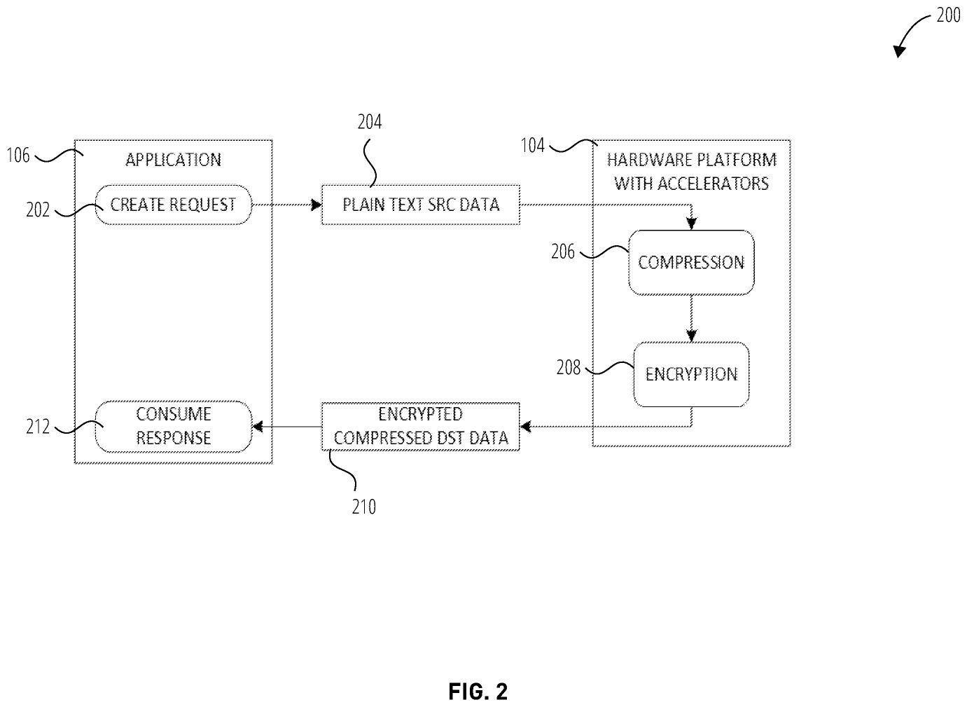

FIG. 2 illustrates a flow diagram 200 for the system 100 to chain multiple operations in the accelerator device 104 using a single request. As shown, at block 202, the application 106 may generate a chaining request to chain two or more services 120 provided by the accelerator device 104. The chaining request may include a session identifier (ID) (e.g., a pointer to the parameters for the session), a pointer to source data 204, and an indication of the services 120 to be chained. In the example depicted in FIG. 2, the services 120 to be chained include compression and encryption. In some embodiments, the chaining request may further include one or more request-specific parameters that are specific to the chaining request (which may not be applied to all requests associated with a session, e.g., not session parameters). Examples of request-specific parameters include a size of one or more packets of source data 204, the location of the source data 204, etc. In some embodiments, the chaining request is issued based on an API call to an API exposed by the accelerator device 104.

The accelerator device 104 may receive the request and determine an order of the requested operations. For example, the accelerator device 104 may include logic to determine an order of operations. For example, the accelerator device 104 may determine to compress the source data 204 then encrypt the compressed data. Therefore, as shown, the accelerator device 104 may compress the data at block 206. The accelerator device 104 may then encrypt the compressed data at block 208, thereby producing encrypted compressed data 210. The requesting application 106 may then consume the response (e.g., the encrypted, compressed data 210) at block 212.

FIG. 3 illustrates an embodiment of a system 300. As shown, the system 300 includes the accelerator device 104 that is accessible to the application 106. As shown, a device driver 306 of the accelerator device 104 executing in a kernel space of an operating system (OS, not pictured) of the system 300 may configure the accelerator device 104 and control the software library 304 in a user space of the OS. The device driver 306 may load and start the firmware 310 of the accelerator device 104. The device driver 306 may further register with the user space software library 304 to enable communication between user space (e.g., the application 106) and the kernel space of the OS (e.g., the device driver 306). For example, the device driver 306 may establish one or more interrupt handlers to handle any errors.

As stated, to use the accelerator device 104, the application 106 may register with the accelerator device 104 via one or more APIs 302 provided by the software library 304 of the accelerator device 104. The application 106 may create an application instance with the accelerator device 104. Doing so may include the creation of a ring pair, namely a request ring 312 and a response ring 314. The request ring 312 may store indications of chaining requests issued by the application 106 via the one or more APIs 302. The response ring 314 may store indications of one or more processed chaining requests to be returned to the application 106. The application 106 may further establish a session with the accelerator device 104 via one or more of the APIs 302. As stated, the session may include one or more session parameters, such as cryptographic algorithms to be used for encryption/decryption operations, hash functions to be used for hash computations, integrity algorithms to be used for data integrity verification, compression algorithms to be used for compression/decompression operations, compression levels, checksum types, priority levels, or any other parameter.

The accelerator device 104 may store the session parameters for the session, thereby allowing the session parameters to be reused for each request to process source packet payload 320. For example, the application 106 may issue a request for a chaining operation 316 for a first packet payload 320 via one or more of the APIs 302. The chaining operation 316 may include a session ID (e.g., a pointer to the parameters for the session), a pointer to the packet payload 320 in memory, and an indication of the services 120 to be chained. The chaining operation 316 may include indications of any combination of services 120 supported by the hardware accelerators 308 of the accelerator device 104. For example, the combination of services 120 may include one or more of: (i) compression and encryption, (ii) decryption and decompression, (iii) hashing and compression, (iv) decompression and hashing, (v) decryption, decompression, and hashing, and/or (vi) hashing, compression, and encryption. Each respective combination of services 120 may be performed in any order. For example, hashing (and/or hash verification) may be performed on plain data, encrypted data, compressed data, and/or encrypted and compressed data. As another example, encryption (and/or decryption) may be performed on plain data and/or compressed data. As another example, compression (and/or decompression) may be performed on plain data and/or encrypted data. Embodiments are not limited in these contexts.

As used herein, hash operations may include computing a hash value based on data and/or performing data integrity operations (e.g., verification using SHA-based or CRC-based algorithms). The data integrity operations may include computing a hash value on data and comparing the computed hash value to another hash value computed based on the data. If the comparison results in a match, the data integrity is verified, as the data has not been altered. If the comparison does not result in a match, the data has changed, and the data integrity fails.

The hardware accelerators 308 include circuitry for one or more hash computation accelerators (for hash-related computations), one or more compression accelerators (for compression and/or decompression-related operations), and one or more cryptographic accelerators (for encryption and/or decryption-related operations). The hash computation accelerators may further include circuitry to perform data integrity verification operations (e.g., verification using SHA-based or CRC-based algorithms). Embodiments are not limited in these contexts, as any other services 120 supported by the hardware accelerators 308 of the accelerator device 104 may be chained based on a chaining operation 316.

The software library 304 may receive the chaining operation 316 from the application 106 and place the chaining operation 316 on the request ring 312 as a chaining request 326 for the application 106. In some embodiments, the software library 304 generates a descriptor (e.g., a message) as the chaining request 326 based on the parameters in the chaining operation 316 and/or the session parameters. In some embodiments, the descriptor is a 128-byte configword. In some embodiments, a service ID of the descriptor indicates that the chaining request 326 is a request to chain two or more operations in the accelerator device 104. For example, the descriptor may include the session parameters, request-specific parameters (e.g., one or more parameters in the chaining operation 316), and an indication that the chaining request 326 is a request to chain two or more operations in the accelerator device 104 (e.g., as the service ID). The software library 304 may use the session parameters for the requested operations to generate the descriptor (e.g., compression-related parameters, cryptography-related parameters, etc.) for the chaining request 326. In some embodiments, a tail pointer of the request ring 312 is updated to point to a location of the descriptor on the request ring 312.

The firmware 310 may receive a notification that the software library 304 has placed the descriptor for the chaining request 326 on the request ring 312. The firmware 310 decodes the descriptor and configures the hardware accelerators 308 to perform the requested operations. In some embodiments, the firmware 310 determines an order of performance for the requested operations. For example, if the chaining request 326 specifies to decompress and decrypt the packet payload 320, the firmware 310 may determine to decrypt the packet payload 320 and decompress the decrypted packet payload 320. The firmware 310 may load the data of the packet payload 320 from the memory location specified in the chaining operation 316 into the memory of the accelerator device 104 (e.g., via direct memory access (DMA)).

Continuing with the previous example, the firmware 310 may then cause one or more of the cryptographic hardware accelerators 308 to decrypt the payload data 320. The cryptographic hardware accelerators 308 may then return an indication to the firmware that the decryption is complete. The indication may specify at least a memory location of the decrypted data. The firmware 310 may then load the decrypted data into memory of the accelerator device 104 and cause one or more of the compression hardware accelerators 308 to decompress the decrypted data to generate one or more processed payloads 324. Once decompressed, the compression hardware accelerators 308 may return an indication to the firmware 310 that the decompression is complete.

The firmware 310 may then place a chaining response 318 on the response ring 314. The chaining response 318 may include a location of the one or more processed payloads 324. The chaining response 318 may further include one or more of: a status, one or more opcodes, how many bytes of data were consumed, how many bytes of data were produced, one or more generated checksum values, data integrity results, and/or one or more generated hash values. In some embodiments, the software library 304 polls the response ring 314 to identify the chaining response 318. In some embodiments, the software library 304 decodes the chaining response 318. The chaining response 318 may be returned to the application 106, which consumes the processed payloads 324. Therefore, the application 106 is notified via a single chaining response 318 for multiple operations, rather than a respective response for each operation.

In some embodiments, the application 106 may register a callback function 322 for a session. Doing so allows the application 106 to be notified when a chaining response 318 is available, e.g., the accelerator device 104 has processed the data pursuant to a given chaining operation 316 during the session. The callback function 322 may be a non-blocking callback function 322. Therefore, the accelerator device 104 may return the callback function 322 to the application 106 to indicate the chaining response 318 is available. In some embodiments, the software library 304 issues the callback to the application 106. In some embodiments, rather than register a callback, the application 106 may periodically poll the software library 304 to determine if a chaining response 318 is available. The software library 304 may then return a response indicating whether the chaining response 318 (and any parameters associated with the chaining response 318, if available).

The application 106 may continue to issue additional requests for chaining operations 316 during the session (which requires only a single session initialization call for the entire session). For example, the application 106 may issue a second chaining operation 316 to decompress and decrypt another payload 320. For example, a second chaining request 326 may be placed on the request ring 312 by the software library 304 based on the second chaining operation 316. The session parameters are then used to process the second chaining operation 316, e.g., to process the second payload 320 using the same compression parameters and decryption parameters that were used to process the first payload 320. Because there is no dependency between two or more chaining operations 316, a stateless mode of operation is provided. Similarly, multiple chaining operations 316 can be issued without having to wait for prior requests to complete.

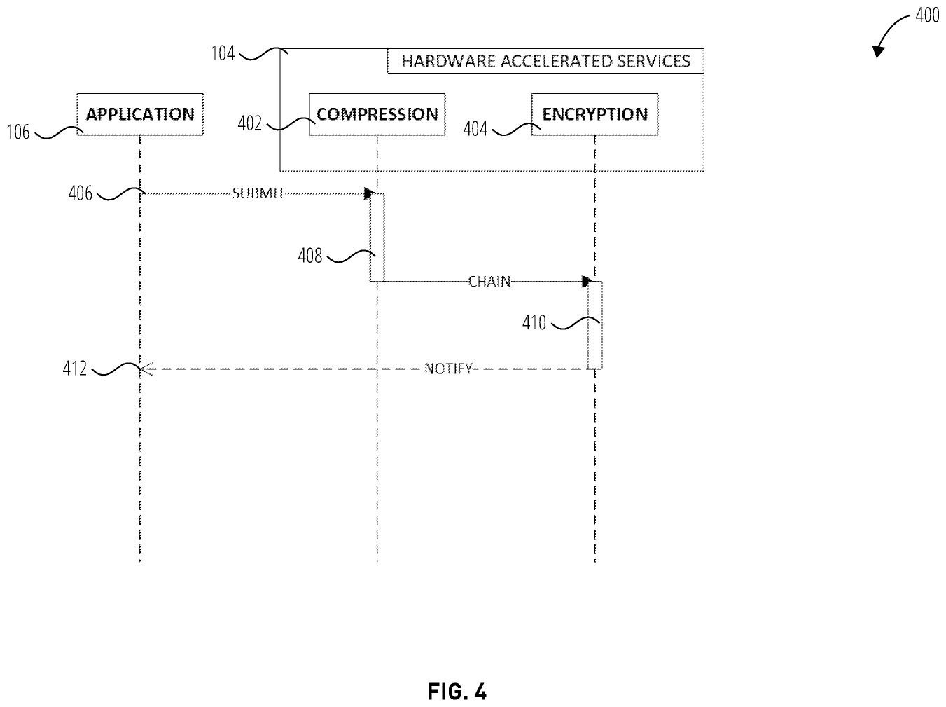

FIG. 4 illustrates an embodiment of a sequence diagram 400. The sequence diagram 400 may be representative of some or all of the operations to process a chaining request to chain two or more services 120 provided by the accelerator device 104. Embodiments are not limited in this context.

At 406, an application 106 may issue a chaining request such as chaining operation 316 to a compression controller 402 of the accelerator device 104. The compression controller 402 may determine an order of operations specified in the chaining operation 316. For example, if the chaining operation 316 is to compress and encrypt data, the compression controller 402 may determine to first compress the data then encrypt the data. At 408, the compression controller 402 may cause one or more of the compression hardware accelerators 308 to compress the data. Once the data is compressed, the compression controller 402 causes a cryptography controller 404 of the accelerator device 104 to encrypt the compressed data at 410. The cryptography controller 404 may cause one or more of the encryption hardware accelerators 308 to encrypt the compressed data. At 412, the application 106 consumes the encrypted compressed data.

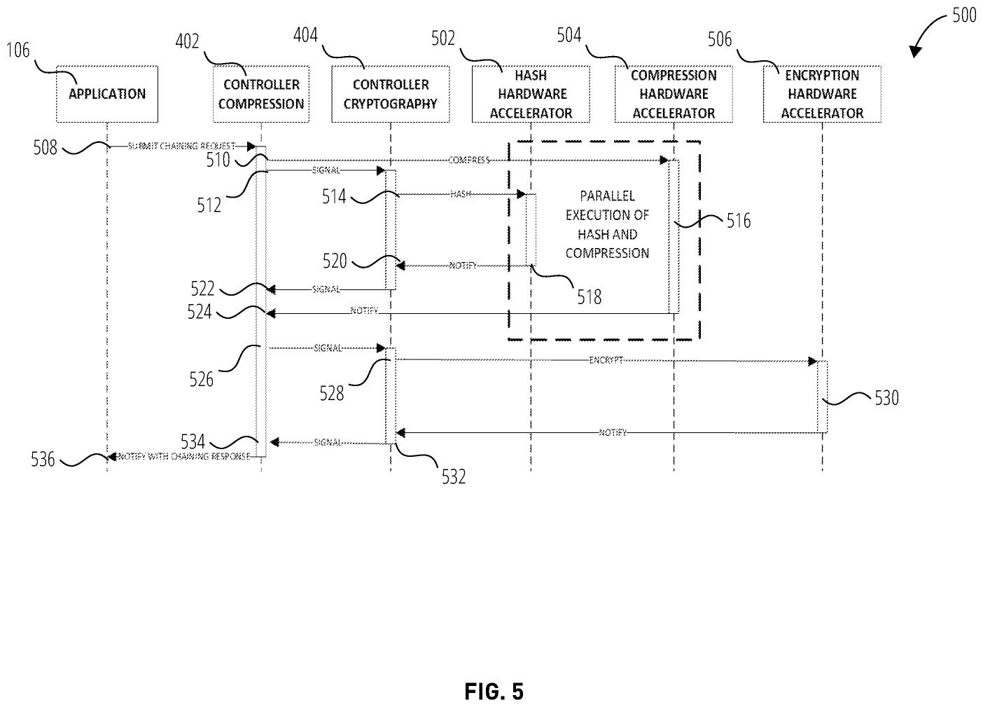

FIG. 5 illustrates an embodiment of a sequence diagram 500. The sequence diagram 500 may be representative of some or all of the operations to process a chaining request to chain two or more services 120 provided by the accelerator device 104 using one or more hash hardware accelerators 502, one or more compression hardware accelerators 504, and one or more cryptography hardware accelerators 506. The hash hardware accelerators 502, compression hardware accelerators 504, and cryptography hardware accelerators 506 are representative of the hardware accelerators 308 of the accelerator device 104. Embodiments are not limited in this context.

At 508, an application 106 may issue a chaining request such as chaining operation 316 to the compression controller 402 of the accelerator device 104. The compression controller 402 may determine an order of operations specified in the chaining operation 316. For example, in the example depicted in FIG. 5, the chaining operation 316 is to compress, hash, and encrypt data. Therefore, the compression controller 402 may determine to compress the data and hash the data in parallel, followed by encrypting the compressed data. At 510, the compression controller 402 may transmit a signal to one or more of the compression hardware accelerators 504 to cause the compression hardware accelerators 504 to compress the data. At 512, the compression controller 402 transmits a signal to the cryptography controller 404. Based on the signal received from the compression controller 402, the cryptography controller 404 transmits an indication at 514 to cause one or more of the hash hardware accelerators 502 to compute a hash value for the data. In some embodiments, the compression controller 402 transmits an instruction directly to the hash hardware accelerator 502 to compute the hash value at 512. The instruction may further cause the hash hardware accelerator 502 to perform a data integrity check based on the hash value.

At 516, one or more of the compression hardware accelerators 504 compresses the data. At 518, the hash hardware accelerator 502 computes a hash value for the data and optionally performs the data integrity check for the data based on the hash value. Generally, 516 and 518 occur in parallel. Stated differently, the compression hardware accelerator 504 may compress the data and the hash hardware accelerator 502 may hash (and/or verify the integrity of) the data in parallel. At 520, the hash hardware accelerator 502 notifies the cryptography controller 404 that the hash computations have completed. At 522, the cryptography controller 404 transmits a signal to the compression controller 402 to notify the compression controller 402 that the data has been hashed. At 524, the compression hardware accelerator 504 transmits a signal to the compression controller 402 to indicate that the data has been compressed.

At 526, the compression controller transmits a signal to the cryptography controller 404 to initiate the encryption of the compressed data. At 528, the cryptography controller 404 causes one or more of the cryptography hardware accelerators 506 to encrypt the compressed data. At 530, one or more of the cryptography hardware accelerators 506 encrypt the compressed data. At 532, the one or more cryptography hardware accelerators 506 notify the compression controller 402 that the data has been encrypted. At 534, the compression controller 402 causes a chaining response 318 to be returned to the application 106. The application 106 may consume the encrypted compressed data at 534.

The operations depicted in FIG. 5 may reflect one chaining request issued by the application 106 during a session with the accelerator device 104. As stated, the application 106 may issue multiple chaining requests during a given session (e.g., to respective requests for multiple portions of a file and/or multiple files). Therefore, the operations depicted in FIG. 5 may be repeated for each chaining request issued during the session. By caching the session parameters, the accelerator device 104 reuses the relevant session parameters for a given request. Furthermore, the dedicated controllers such as cryptography controller 404, compression controller 402 allow cryptographic and compression operations to be processed independently.

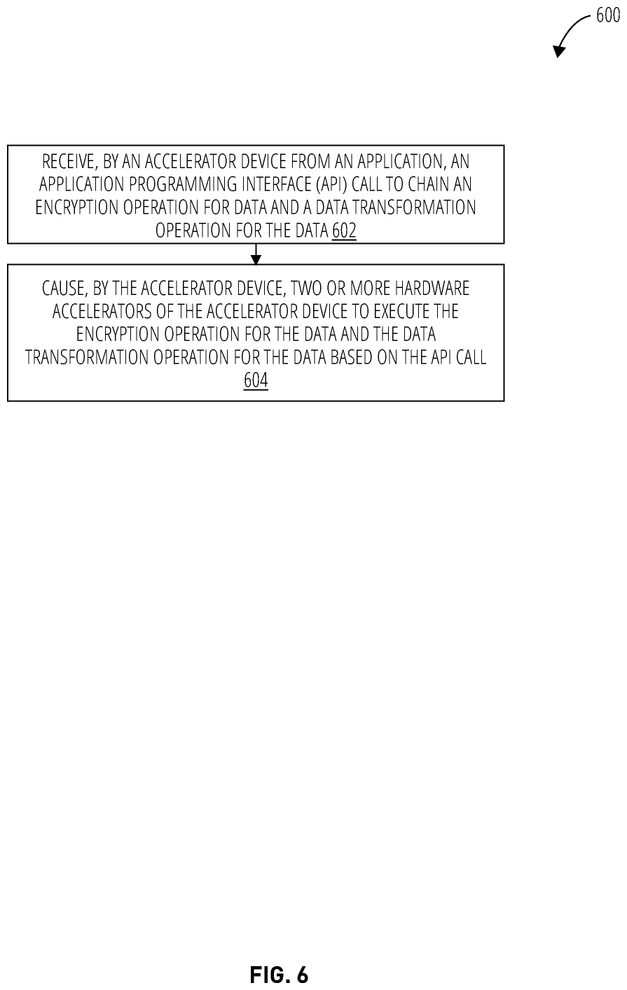

FIG. 6 illustrates an embodiment of a logic flow 600. The logic flow 600 may be representative of some or all of the operations executed by one or more embodiments described herein. For example, the logic flow 600 may include some or all of the operations to chain services in an accelerator device. Embodiments are not limited in this context.

In block 602, logic flow 600 receives, by an accelerator device 104 from an application such the application 106, an application programming interface (API) call to chain an encryption operation for data such as the source data 110 or 204 and a data transformation operation for the data. For example, the data transformation operation may be one or more of a compression operation, a hash operation, or any type of data transformation operation. In block 604, logic flow 600 causes, by the accelerator device 104, two or more hardware accelerators of the accelerator device to execute the encryption operation for the data and the data transformation operation for the data based on the API call.

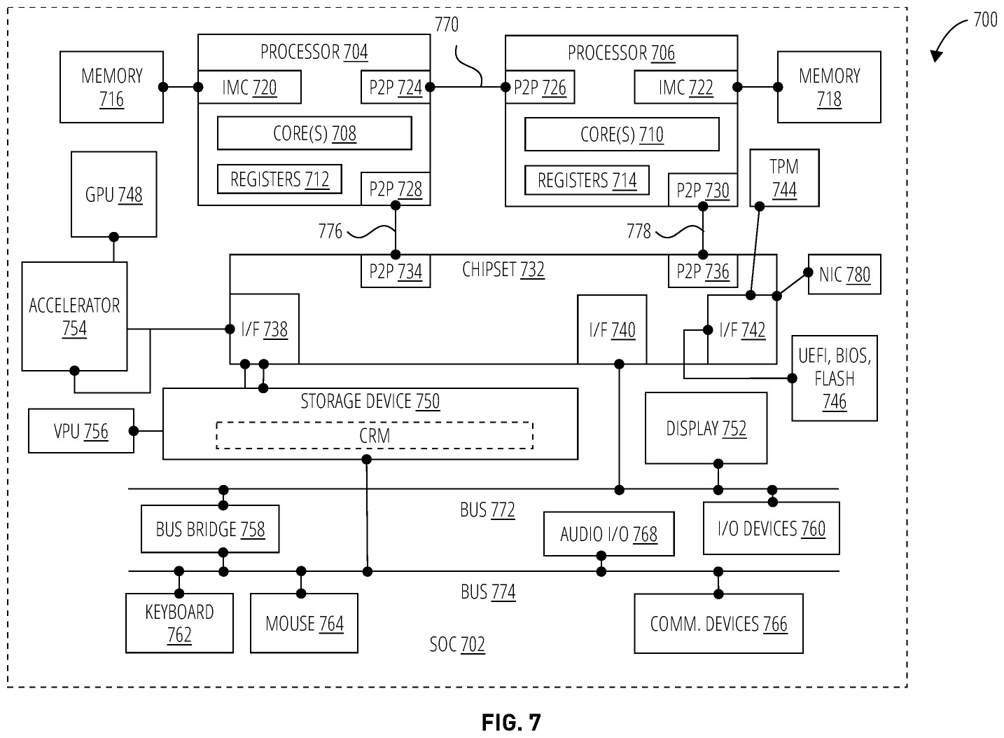

FIG. 7 illustrates an embodiment of a system 700. System 700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), an Infrastructure Processing Unit (IPU), a data processing unit (DPU), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. Examples of IPUs include the Intel® IPU and the AMD® Pensando IPU. Examples of DPUs include the Intel DPU, the Fungible DPU, the Marvell® OCTEON and ARMADA DPUs, the NVIDIA BlueField® DPU, the ARM® Neoverse N2 DPU, and the AMD® Pensando DPU. In other embodiments, the system 700 may have a single processor with one core or more than one processor. Note that the term “processor” refers to a processor with a single core or a processor package with multiple processor cores. In at least one embodiment, the computing system 700 is representative of the components of the systems 100, 300. In at least one embodiment, the computing system 700 is representative of the hardware platform 102. More generally, the computing system 700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 7, system 700 comprises a system-on-chip (SoC) 702 for mounting platform components. System-on-chip (SoC) 702 is a point-to-point (P2P) interconnect platform that includes a first processor 704 and a second processor 706 coupled via a point-to-point interconnect 770 such as an Ultra Path Interconnect (UPI). In other embodiments, the system 700 may be of another bus architecture, such as a multi-drop bus. Furthermore, each of processor 704 and processor 706 may be processor packages with multiple processor cores including core(s) 708 and core(s) 710, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 704 and chipset 732. Some platforms may include additional components and some platforms may only include sockets to mount the processors and/or the chipset. Furthermore, some platforms may not have sockets (e.g. SoC, or the like). Although depicted as a SoC 702, one or more of the components of the SoC 702 may also be included in a single die package, a multi-chip module (MCM), a multi-die package, a chiplet, a bridge, and/or an interposer. Therefore, embodiments are not limited to a SoC.

The processor 704 and processor 706 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 704 and/or processor 706. Additionally, the processor 704 need not be identical to processor 706.

Processor 704 includes an integrated memory controller (IMC) 720 and point-to-point (P2P) interface 724 and P2P interface 728. Similarly, the processor 706 includes an IMC 722 as well as P2P interface 726 and P2P interface 730. IMC 720 and IMC 722 couple the processor 704 and processor 706, respectively, to respective memories (e.g., memory 716 and memory 718). Memory 716 and memory 718 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 716 and the memory 718 locally attach to the respective processors (e.g., processor 704 and processor 706). In other embodiments, the main memory may couple with the processors via a bus and shared memory hub. Processor 704 includes registers 712 and processor 706 includes registers 714.

System 700 includes chipset 732 coupled to processor 704 and processor 706. Furthermore, chipset 732 can be coupled to storage device 750, for example, via an interface (I/F) 738. The I/F 738 may be, for example, a Peripheral Component Interconnect-enhanced (PCIe) interface, a Compute Express Link® (CXL) interface, or a Universal Chiplet Interconnect Express (UCIe) interface. Storage device 750 can store instructions executable by circuitry of system 700 (e.g., processor 704, processor 706, GPU 748, accelerator 754, vision processing unit 756, or the like). For example, storage device 750 can store instructions for the application 106, the APIs 302, the software library 304, the firmware 310, or the like.

Processor 704 couples to the chipset 732 via P2P interface 728 and P2P 734 while processor 706 couples to the chipset 732 via P2P interface 730 and P2P 736. Direct media interface (DMI) 776 and DMI 778 may couple the P2P interface 728 and the P2P 734 and the P2P interface 730 and P2P 736, respectively. DMI 776 and DMI 778 may be a high-speed interconnect that facilitates, e.g., eight Giga Transfers per second (GT/s) such as DMI 3.0. In other embodiments, the processor 704 and processor 706 may interconnect via a bus.

The chipset 732 may comprise a controller hub such as a platform controller hub (PCH). The chipset 732 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 732 may comprise more than one controller hub such as a chipset with a memory controller hub, a graphics controller hub, and an input/output (I/O) controller hub.

In the depicted example, chipset 732 couples with a trusted platform module (TPM) 744 and UEFI, BIOS, FLASH circuitry 746 via I/F 742. The TPM 744 is a dedicated microcontroller designed to secure hardware by integrating cryptographic keys into devices. The UEFI, BIOS, FLASH circuitry 746 may provide pre-boot code.

Furthermore, chipset 732 includes the I/F 738 to couple chipset 732 with a high-performance graphics engine, such as, graphics processing circuitry or a graphics processing unit (GPU) 748. In other embodiments, the system 700 may include a flexible display interface (FDI) (not shown) between the processor 704 and/or the processor 706 and the chipset 732. The FDI interconnects a graphics processor core in one or more of processor 704 and/or processor 706 with the chipset 732.

The system 700 is operable to communicate with wired and wireless devices or entities via the network interface controller (NIC) 780 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 754 and/or vision processing unit 756 can be coupled to chipset 732 via I/F 738. The accelerator 754 is representative of the accelerator device 104. In some embodiments, the GPU 748 is representative of the accelerator device 104. The accelerator 754 is representative of any type of accelerator device (e.g., a cryptographic accelerator, cryptographic co-processor, GPU, an offload engine, etc.). One example of an accelerator 754 is the Intel® QuickAssist Technology (QAT). Another example of an accelerator 754 is the Intel in-memory analytics accelerator (IAA). Other examples of accelerators 754 include the AMD Instinct® or Radeon® accelerators. Other examples of accelerators 754 include the NVIDIA® HGX and SCX accelerators. Another example of an accelerator 754 includes the ARM Ethos-U NPU.

The accelerator 754 may be a device including circuitry to accelerate cryptographic operations, hash value computation, data comparison operations (including comparison of data in memory 716 and/or memory 718), and/or data compression operations. For example, the accelerator 754 may be a USB device, PCI device, PCIe device, CXL device, UCIe device, and/or an SPI device. The accelerator 754 can also include circuitry arranged to execute machine learning (ML) related operations (e.g., training, inference, etc.) for ML models. Generally, the accelerator 754 may be specially designed to perform computationally intensive operations, such as hash value computations, comparison operations, cryptographic operations, and/or compression operations, in a manner that is more efficient than when performed by the processor 704 or processor 706. Because the load of the system 700 may include hash value computations, comparison operations, cryptographic operations, and/or compression operations, the accelerator 754 can greatly increase performance of the system 700 for these operations.

The accelerator 754 may be embodied as any type of device, such as a coprocessor, application-specific integrated circuit (ASIC), field-programmable gate array (FPGA), functional block, IP core, graphics processing unit (GPU), a processor with specific instruction sets for accelerating one or more operations, or other hardware accelerator of the computing device 202 capable of performing the functions described herein. In some embodiments, the accelerator 754 may be packaged in a discrete package, an add-in card, a chipset, a multi-chip module (e.g., a chiplet, a dielet, etc.), and/or an SoC. Embodiments are not limited in these contexts.

The accelerator 754 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 754. For example, the accelerator 754 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 754 via a non-posted write (e.g., a deferred memory write (DMWr)). One example of an instruction that atomically submits a work descriptor to the shared work queue of the accelerator 754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 754. The dedicated work queue may accept job submissions via commands such as the movdir64b instruction.

Various I/O devices 760 and display 752 couple to the bus 772, along with a bus bridge 758 which couples the bus 772 to a second bus 774 and an I/F 740 that connects the bus 772 with the chipset 732. In one embodiment, the second bus 774 may be a low pin count (LPC) bus. Various devices may couple to the second bus 774 including, for example, a keyboard 762, a mouse 764 and communication devices 766.

Furthermore, an audio I/O 768 may couple to second bus 774. Many of the I/O devices 760 and communication devices 766 may reside on the system-on-chip (SoC) 702 while the keyboard 762 and the mouse 764 may be add-on peripherals. In other embodiments, some or all the I/O devices 760 and communication devices 766 are add-on peripherals and do not reside on the system-on-chip (SoC) 702.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.
Example 1 includes an accelerator device, comprising: a plurality of hardware accelerators; and circuitry configured to execute one or more instructions to cause the circuitry to: receive, from an application, an application programming interface (API) call to chain an encryption operation for data and a data transformation operation for the data; and cause two or more of the hardware accelerators to execute the encryption operation for the data and the data transformation operation for the data based on the API call.
Example 2 includes the subject matter of example 1, the circuitry configured to execute one or more instructions to cause the circuitry to: determine an order of execution for the encryption operation and the data transformation operation; and cause the two or more of the hardware accelerators to execute the encryption operation and the data transformation operation according to the determined order.
Example 3 includes the subject matter of example 1, wherein the data transformation operation is to comprise a compression operation, wherein the two or more of the hardware accelerators are to comprise an encryption accelerator and a compression accelerator, the circuitry configured to execute one or more instructions to cause the circuitry to: cause the compression accelerator to compress the data to produce compressed data; and cause the encryption accelerator to encrypt the compressed data to produce encrypted compressed data.
Example 4 includes the subject matter of example 1, wherein the data transformation operation is to comprise a compression operation and a hash operation, wherein the circuitry is configured to cause the two or more of the hardware accelerators to execute the compression operation and the hash operation in parallel.
Example 5 includes the subject matter of example 1, the circuitry configured to execute one or more instructions to cause the circuitry to, prior to the receipt of the API call: establish a session with the application; and receive, from the application, one or more parameters for the session.
Example 6 includes the subject matter of example 5, the one or more parameters to comprise an encryption algorithm for the data and a parameter for the data transformation operation.
Example 7 includes the subject matter of example 5, the circuitry configured to execute one or more instructions to cause the circuitry to: receive, from the application, another API call to chain the encryption operation and data transformation operation for another data; and cause two or more of the hardware accelerators to execute the encryption operation for the another data and the data transformation operation for the another data based at least in part on the one or more parameters for the session.
Example 8 includes the subject matter of example 1, the circuitry configured to execute one or more instructions to cause the circuitry to: return, to the application, a callback to indicate completion of the encryption operation and the data transformation operation.
Example 9 includes a non-transitory computer-readable storage medium, the computer-readable storage medium including instructions that when executed by an accelerator device, cause the accelerator device to: receive, from an application, an application programming interface (API) call to chain an encryption operation for data and a data transformation operation for the data; and cause two or more hardware accelerators of the accelerator device to execute the encryption operation for the data and the data transformation operation for the data based on the API call.
Example 10 includes the subject matter of example 9, wherein the instructions further cause the accelerator device to: determine an order of execution for the encryption operation and the data transformation operation; and cause the two or more hardware accelerators to execute the encryption operation and the data transformation operation according to the determined order.
Example 11 includes the subject matter of example 9, wherein the data transformation operation is to comprise a compression operation, wherein the two or more hardware accelerators are to comprise an encryption accelerator and a compression accelerator, wherein the instructions further cause the accelerator device to: cause the compression accelerator to compress the data to produce compressed data; and cause the encryption accelerator to encrypt the compressed data to produce encrypted compressed data.
Example 12 includes the subject matter of example 9, wherein the data transformation operation is to comprise a compression operation and a hash operation, wherein the instructions further cause the accelerator device to cause the two or more hardware accelerators to execute the compression operation and the hash operation in parallel.
Example 13 includes the subject matter of example 9, wherein the instructions further cause the accelerator device to, prior to the receipt of the API call: establish a session with the application; and receive one or more parameters for the session.
Example 14 includes the subject matter of example 13, the one or more parameters to comprise an encryption algorithm for the data and a parameter for the data transformation operation.
Example 15 includes the subject matter of example 13, wherein the instructions further cause the accelerator device to: receive, from the application, another API call to chain the encryption operation and data transformation operation for another data; and cause two or more of the hardware accelerators to execute the encryption operation for the another data and the data transformation operation for the another data based at least in part on the one or more parameters for the session.
Example 16 includes the subject matter of example 9, wherein the instructions further cause the accelerator device to: return, to the application, a callback to indicate completion of the encryption operation and the data transformation operation.
Example 17 includes a method, comprising: receiving, by an accelerator device from an application, an application programming interface (API) call to chain an encryption operation for data and a data transformation operation for the data; and causing, by the accelerator device, two or more hardware accelerators of the accelerator device to execute the encryption operation for the data and the data transformation operation for the data based on the API call.
Example 18 includes the subject matter of example 17, further comprising: determining, by the accelerator device, an order of execution for the encryption operation and the data transformation operation; and causing, by the accelerator device, the two or more hardware accelerators to execute the encryption operation and the data transformation operation according to the determined order.
Example 19 includes the subject matter of example 17, wherein the data transformation operation is to comprise a compression operation, wherein the two or more hardware accelerators are to comprise an encryption accelerator and a compression accelerator, the method further comprising: causing, by the accelerator device, the compression accelerator to compress the data to produce compressed data; and causing, by the accelerator device, the encryption accelerator to encrypt the compressed data to produce encrypted compressed data.
Example 20 includes the subject matter of example 17, wherein the data transformation operation is to comprise a compression operation and a hash operation, wherein the accelerator device is configured to cause the two or more hardware accelerators to execute the compression operation and the hash operation in parallel.
Example 21 includes the subject matter of example 17, further comprising prior to the receipt of the API call: establishing, by the accelerator device, a session with the application; and receiving, by the accelerator device from the application, one or more parameters for the session.
Example 22 includes the subject matter of example 21, the one or more parameters to comprise an encryption algorithm for the data and a parameter for the data transformation operation.
Example 23 includes the subject matter of example 21, further comprising: receiving, by the accelerator device from the application, another API call to chain the encryption operation and data transformation operation for another data; and causing, by the accelerator device, two or more of the hardware accelerators to execute the encryption operation for the another data and the data transformation operation for the another data based at least in part on the one or more parameters for the session.
Example 24 includes the subject matter of example 17, further comprising: returning, by the accelerator device to the application, a callback to indicate completion of the encryption operation and the data transformation operation.
Example 25 includes an apparatus, comprising: means for receiving, by an accelerator device from an application, an application programming interface (API) call to chain an encryption operation for data and a data transformation operation for the data; and means for causing two or more hardware accelerators of the accelerator device to execute the encryption operation for the data and the data transformation operation for the data based on the API call.
Example 26 includes the subject matter of example 25, further comprising: means for determining an order of execution for the encryption operation and the data transformation operation; and means for causing the two or more hardware accelerators to execute the encryption operation and the data transformation operation according to the determined order.
Example 27 includes the subject matter of example 25, wherein the data transformation operation is to comprise a compression operation, wherein the two or more hardware accelerators are to comprise an encryption accelerator and a compression accelerator, the method further comprising: means for causing the compression accelerator to compress the data to produce compressed data; and means for causing the encryption accelerator to encrypt the compressed data to produce encrypted compressed data.
Example 28 includes the subject matter of example 25, wherein the data transformation operation is to comprise a compression operation and a hash operation, wherein the accelerator device is configured to cause the two or more hardware accelerators to execute the compression operation and the hash operation in parallel.
Example 29 includes the subject matter of example 25, further comprising prior to the receipt of the API call: means for establishing a session with the application; and means for receiving, from the application, one or more parameters for the session.
Example 30 includes the subject matter of example 29, the one or more parameters to comprise an encryption algorithm for the data and a parameter for the data transformation operation.
Example 31 includes the subject matter of example 29, further comprising: means for receiving, from the application, another API call to chain the encryption operation and data transformation operation for another data; and means for causing two or more of the hardware accelerators to execute the encryption operation for the another data and the data transformation operation for the another data based at least in part on the one or more parameters for the session.
Example 32 includes the subject matter of example 25, further comprising: means for returning, to the application, a callback to indicate completion of the encryption operation and the data transformation operation.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An accelerator device, comprising:
a plurality of hardware accelerators; and
circuitry configured to execute one or more instructions to cause the circuitry to:
receive, from an application, an application programming interface (API) call to chain an encryption operation for data and a data transformation operation for the data; and
cause two or more of the hardware accelerators to execute the encryption operation for the data and the data transformation operation for the data based on the API call.

2. The accelerator device of claim 1, the circuitry configured to execute one or more instructions to cause the circuitry to:
determine an order of execution for the encryption operation and the data transformation operation; and
cause the two or more of the hardware accelerators to execute the encryption operation and the data transformation operation according to the determined order.

3. The accelerator device of claim 1, wherein the data transformation operation is to comprise a compression operation, wherein the two or more of the hardware accelerators are to comprise an encryption accelerator and a compression accelerator, the circuitry configured to execute one or more instructions to cause the circuitry to:
cause the compression accelerator to compress the data to produce compressed data; and
cause the encryption accelerator to encrypt the compressed data to produce encrypted compressed data.

4. The accelerator device of claim 1, wherein the data transformation operation is to comprise a compression operation and a hash operation, wherein the circuitry is configured to cause the two or more of the hardware accelerators to execute the compression operation and the hash operation in parallel.

5. The accelerator device of claim 1, the circuitry configured to execute one or more instructions to cause the circuitry to, prior to the receipt of the API call:
establish a session with the application; and
receive, from the application, one or more parameters for the session.

6. The accelerator device of claim 5, the one or more parameters to comprise an encryption algorithm for the data and a parameter for the data transformation operation.

7. The accelerator device of claim 5, the circuitry configured to execute one or more instructions to cause the circuitry to:
receive, from the application, another API call to chain the encryption operation and data transformation operation for another data; and
cause two or more of the hardware accelerators to execute the encryption operation for the another data and the data transformation operation for the another data based at least in part on the one or more parameters for the session.

8. The accelerator device of claim 1, the circuitry configured to execute one or more instructions to cause the circuitry to:
return, to the application, a callback to indicate completion of the encryption operation and the data transformation operation.

9. A non-transitory computer-readable storage medium, the computer-readable storage medium including instructions that when executed by an accelerator device, cause the accelerator device to:
receive, from an application, an application programming interface (API) call to chain an encryption operation for data and a data transformation operation for the data; and
cause two or more hardware accelerators of the accelerator device to execute the encryption operation for the data and the data transformation operation for the data based on the API call.

10. The computer-readable storage medium of claim 9, wherein the instructions further cause the accelerator device to:
determine an order of execution for the encryption operation and the data transformation operation; and
cause the two or more hardware accelerators to execute the encryption operation and the data transformation operation according to the determined order.

11. The computer-readable storage medium of claim 9, wherein the data transformation operation is to comprise a compression operation, wherein the two or more hardware accelerators are to comprise an encryption accelerator and a compression accelerator, wherein the instructions further cause the accelerator device to:
cause the compression accelerator to compress the data to produce compressed data; and
cause the encryption accelerator to encrypt the compressed data to produce encrypted compressed data.

12. The computer-readable storage medium of claim 9, wherein the data transformation operation is to comprise a compression operation and a hash operation, wherein the instructions further cause the accelerator device to cause the two or more hardware accelerators to execute the compression operation and the hash operation in parallel.

13. The computer-readable storage medium of claim 9, wherein the instructions further cause the accelerator device to, prior to the receipt of the API call:
establish a session with the application; and
receive one or more parameters for the session.

14. The computer-readable storage medium of claim 13, the one or more parameters to comprise an encryption algorithm for the data and a parameter for the data transformation operation.

15. The computer-readable storage medium of claim 9, wherein the instructions further cause the accelerator device to:
return, to the application, a callback to indicate completion of the encryption operation and the data transformation operation.

16. A method, comprising:
receiving, by an accelerator device from an application, an application programming interface (API) call to chain an encryption operation for data and a data transformation operation for the data; and
causing, by the accelerator device, two or more hardware accelerators of the accelerator device to execute the encryption operation for the data and the data transformation operation for the data based on the API call.

17. The method of claim 16, further comprising:
determining, by the accelerator device, an order of execution for the encryption operation and the data transformation operation; and
causing, by the accelerator device, the two or more hardware accelerators to execute the encryption operation and the data transformation operation according to the determined order.

18. The method of claim 16, wherein the data transformation operation is to comprise a compression operation, wherein the two or more hardware accelerators are to comprise an encryption accelerator and a compression accelerator, the method further comprising:
causing, by the accelerator device, the compression accelerator to compress the data to produce compressed data; and
causing, by the accelerator device, the encryption accelerator to encrypt the compressed data to produce encrypted compressed data.

19. The method of claim 16, wherein the data transformation operation is to comprise a compression operation and a hash operation, wherein the accelerator device is configured to cause the two or more hardware accelerators to execute the compression operation and the hash operation in parallel.

20. The method of claim 16, further comprising prior to the receipt of the API call:
establishing, by the accelerator device, a session with the application; and
receiving, by the accelerator device from the application, one or more parameters for the session.
